(19) United States
(12) Patent Application Publication
(10) Pub. No.: US 2013/0240631 A1
(43) Pub. Date: Sep. 19, 2013

(54) CONTAINER CAP HAVING IDENTIFICATION FUNCTION AND ITS MANUFACTURING METHOD

(71) Applicant: SHENG-CHANG HUANG, KAOHSIUNG CITY (TW)

(72) Inventor: SHENG-CHANG HUANG, KAOHSIUNG CITY (TW)

(73) Assignees: SUPREME TECHNIC PACKAGE CO., LTD., KAOHSIUNG CITY (TW); SHENG-CHANG HUANG, KAOHSIUNG CITY (TW)

(21) Appl. No.: 13/421,693

(22) Filed: Mar. 15, 2012

(51) Int. Cl. G06K 19/077; B29C 67/00; B29C 49/24; B29C 45/14

(52) U.S. Cl. 235/488; 264/259; 264/101; 264/509

(57) ABSTRACT

A container cap having identification function and its manufacturing method includes a cap and a radio frequency identification label provided with a radio frequency identification system and an antenna with extension antennas. The cap has a top wall formed with an extending-down circumferential surface having its under side disposed with a positioning circumference. A method for manufacturing such a container cap is to have the label combined with a male mold of a cap-shaping mold in advance to let the main body of the label combined with the inner side of the top wall of the cap, and the extension portion of the label combined with the circumferential surface and extended to the positioning circumference of the cap. When the container cap is turned open, parts of the extension antennas will be broken off for blocking or sending forth radio frequency identification signals, thus producing efficacies of anti-counterfeiting and anti-theft.

### BACKGROUND OF THE INVENTION

1. Field of the Invention

This invention relates to a container cap having identification function and its manufacturing method. A method of manufacturing such a container cap is to have a label placed in a male mold of a cap-shaping mold in advance to let the main body of the label contacting with the inner side of the top wall of a cap and the extensions of the label contacting with the circumferential surface and extended to the positioning circumference of the cap when the cap body is being shaped. When the container cap is turned open, an abuttal portion between the circumferential surface and the positioning circumference of the cap is to be torn off, letting partial extension antennas broken off to block off or send forth radio frequency identification signals, thus producing efficacies of anti-counterfeiting and anti-theft.

2. Description of the Prior Art

A conventional radio frequency identification bottle cap, as disclosed in a Taiwan patent No. M355918, titled “ANTI-COUNTERFEITING BOTTLE CAP”, includes a main body, a neck and at least one joint portion. A gap is formed between the main body and the neck and the joint portion traverses the gap and connected with both the main body and the neck. The radio frequency system label is provided on the cap, with a first antenna and a chip disposed in the main body of the cap, a second antenna positioned in the neck of the cap and a third antenna traversing the gap and bridging both the first antenna and the second antenna.

When the anti-counterfeiting bottle cap is turned around, the neck will not be rotated together with the main body because a stop projection resists against at least one stop block of the bottle body and meanwhile, the joint portion will be broken and separated from the main body or from the neck because the joint portion traverses the gap and connected with the main body and the neck. In addition, since the first antenna and the chip are secured with the main body of the cap, the second antenna is fixed with the neck and the third antenna traverses the gap and is bridged with both the first antenna and the second antenna, therefore, when the anti-counterfeiting bottle cap is turned around, the third antenna will be broken and separated from the first and the second antenna and lose electrical function to disable a reader to read all the data stored by the radio frequency system label, thus able to confirm whether or not the anti-counterfeiting bottle cap was opened.

Obviously, the conventional anti-counterfeiting bottle cap makes use of the third antenna of the radio frequency system label to electrically connect with the second antenna and the third antenna and is based on the situation whether the data stored by the radio frequency system label can be read to confirm whether the anti-counterfeiting bottle cap was opened. However, bottled products for sale, such as expensive drugs, chemical materials or raw materials, need to be worried about whether they were opened and also need to be prevented from being stolen by thieves. To steal such bottled products, a thief may destroy the induction function of radio frequency identification system by means of destroying tools or in a way of heating, for example, apparatuses that can produce high energy, such as micro-wave ovens that are to be tried out for sale. Thus, the radio frequency identification system of the bottled products will lose efficacy of anti-theft and will result in losses to shop owners. Moreover, when the conventional anti-counterfeiting bottle cap is turned open, a condition that the third antenna cannot be torn off and separated from the second antenna will always occur and as a result, the radio frequency identification signal cannot timely be blocked off, thus impossible to produce a marked effect of anti-counterfeiting.

### SUMMARY OF THE INVENTION

The objective of this invention is to offer a container cap having identification function and its manufacturing method, able to produce marked effects of anti-counterfeiting and anti-theft.

The container cap having identification function in the present invention includes a radio frequency identification label having a protective layer stuck thereon. The radio frequency identification label is made by having a radio frequency identification system provided on a substratum and having one side of the radio frequency identification system disposed with a gluey layer to be stuck with the protective layer.

The container cap having identification function in the present invention has the label provided with a main body for receiving the radio frequency identification system and antennas together with extension antennas. The main body of the label is formed with a plurality of extensions for setting the extension antennas thereon.

A method for manufacturing a container cap having identification function is to have the label placed in a male mold of a cap-shaping mold beforehand. When the cap is being shaped in the mold, the main body of the label will be contacting with the inner side of the top wall of the cap and the extension portions of the label will be contacting with the circumferential surface and extended to the positioning circumference of the cap. Thus, when the container cap is turned open, an abuttal portion of the circumferential surface and the positioning circumference of the cap will be torn off, letting partial extension antennas broken off to disconnect or send forth radio frequency signals for producing efficacies of anti-counterfeiting and anti-theft.

### BRIEF DESCRIPTION OF DRAWINGS

This invention will be better understood by referring to the accompanying drawings, wherein:

FIG. 1 is an upper view of a first step of a label manufacturing process in the present invention;

FIG. 2 is cross-sectional and partial magnified view of the first step of the label manufacturing process in the present invention;

FIG. 3 is an upper view of a second step of the label manufacturing process in the present invention;

FIG. 4 is a cross-sectional and partial magnified view of the second step of the label manufacturing process in the present invention;

FIG. 5 is an upper view of a third step of the label manufacturing process in the present invention;

FIG. 6 is a cross-sectional and partial magnified view of the third step of the label manufacturing process in the present invention;

FIG. 7 is an upper view of a fourth step of the label manufacturing process in the present invention;

FIG. 8 is an upper view of the fourth step of the label manufacturing process in the present invention, illustrating that the label is separately cut into shape after molded;

FIG. 9 is an upper view of a fifth step of the label manufacturing process in the present invention, showing a separated label;

FIG. 10 is an upper view of the fifth step of the label manufacturing process in the present invention;

FIG. 11 is a cross-sectional and partial magnified view of the fifth step of the label manufacturing process in the present invention;

FIG. 12 is an upper view of a second preferred embodiment of the label in the present invention;

FIG. 13 is an upper view of a third preferred embodiment of the label in the present invention;

FIG. 14 is an upper view of a fourth preferred embodiment of the label in the present invention;

FIG. 15 is a cross-sectional view of the label combined with a cap-shaping mold in the present invention;

FIG. 16 is a cross-sectional view of the label combined with a cap after the cap is shaped in the shaping mold in the present invention;

FIG. 17 is a schematic view of the cap combined with a container in the present invention; and

FIG. 18 is a partial magnified view of combination of the cap with the container in the present invention.

### DETAILED DESCRIPTION OF THE PREFERRED EMBODIMENT

A first preferred embodiment of a container cap having identification function and its manufacturing method in the present invention, as shown in FIGS.

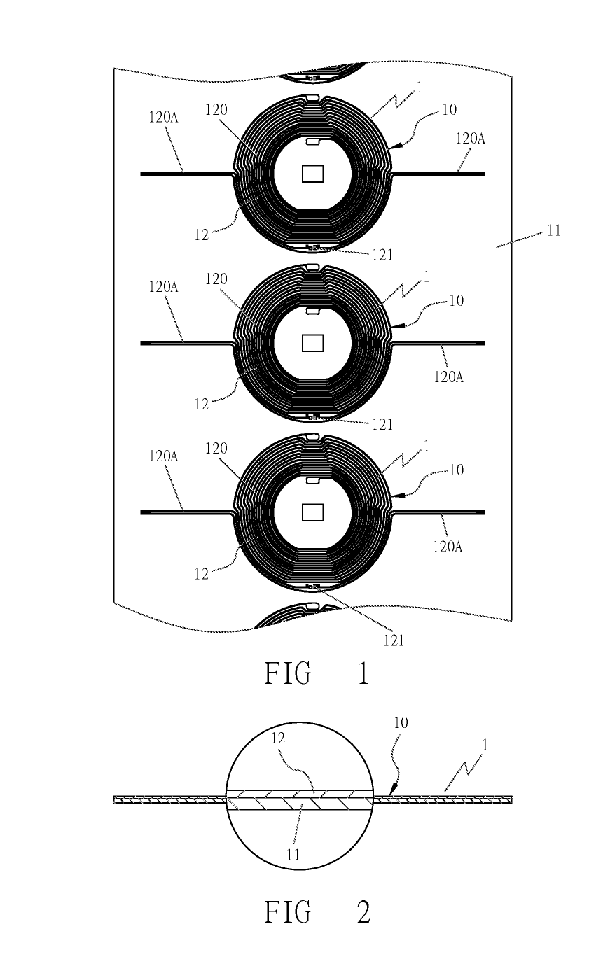

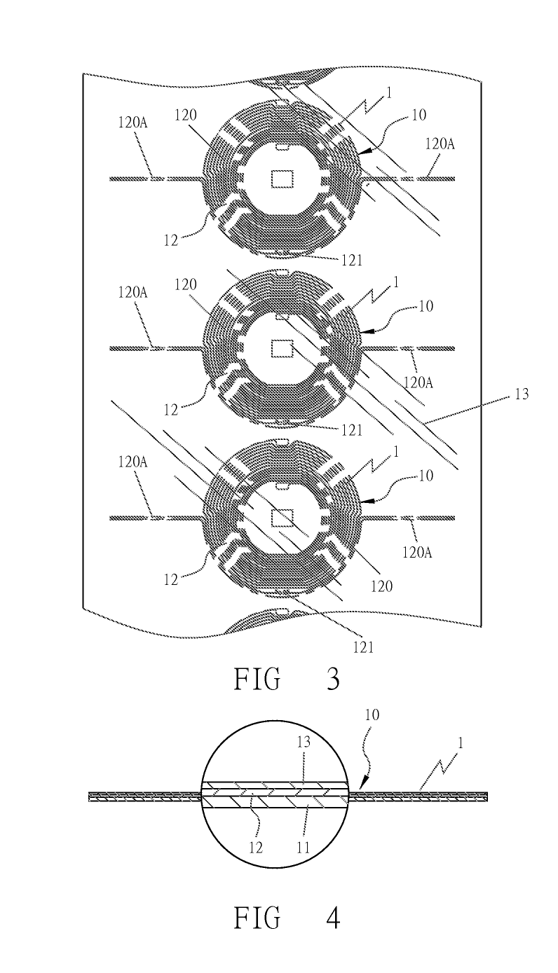

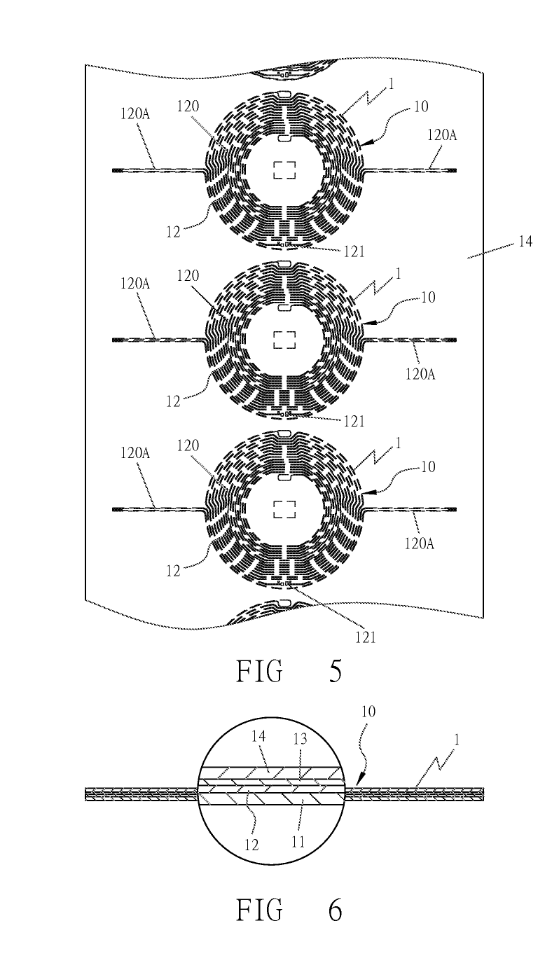

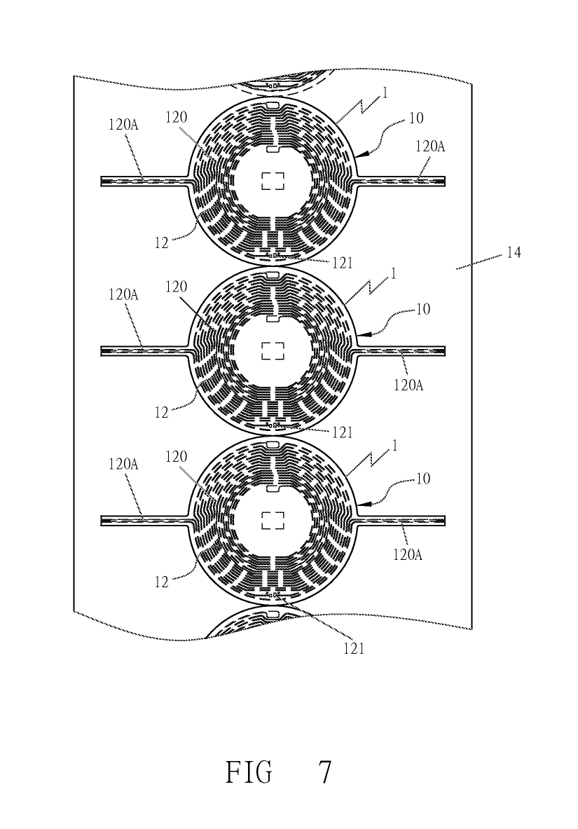

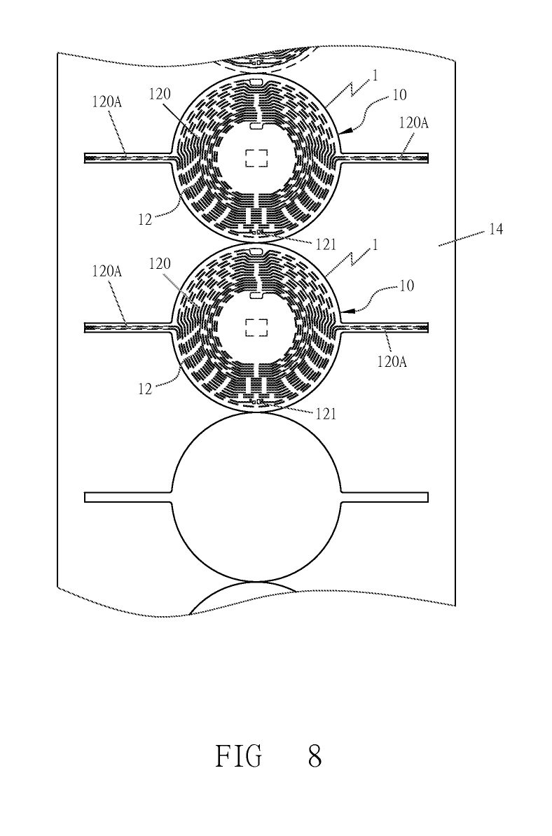

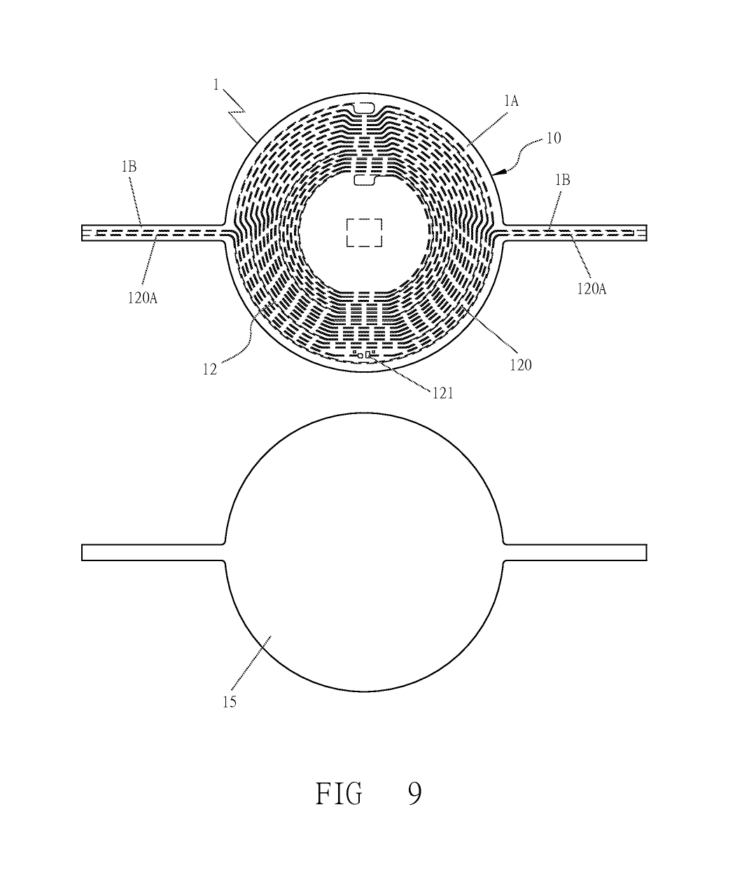

1-4, includes a label 1 provided with a radio frequency identification label 10. A first step of manufacturing the radio frequency identification label 10 is to have antennas 120 of a radio frequency identification system 12 printed or engraved on a substratum plate 11, as shown in FIGS. 1 and 2, and then have the identification chips 121 of the radio frequency identification system 12 fixed on the substratum plate 11 and connected with the antennas via surface-mount technique (SMT). A second step is to apply adhesive material to one side of the radio frequency identification system 12 on the substratum plate 11 to make up a gluey layer 13, as shown in FIGS. 3 and 4. A third step is to have a separable layer 14 stuck on the gluey layer 13 of both the substratum plate 11 and the radio frequency identification system 12, as shown in FIGS. 5 and 6. A fourth step is to have all the radio frequency identification labels 10 respectively cut into shape for facilitating each radio frequency identification label 10 to be removed from the separable layer 14, as shown in FIGS. 7 and 8. A fifth step is to remove the radio frequency identification labels 10 from the separable layer 14 and have each radio frequency identification label 10 stuck thereon with a protective layer 15, which is the same as or partially different from the radio frequency identification label 10 in external looks, as shown in FIGS. 9-11. Thus, the label 1 is composed of the radio frequency identification label 10 and the protective layer 15 stuck together.

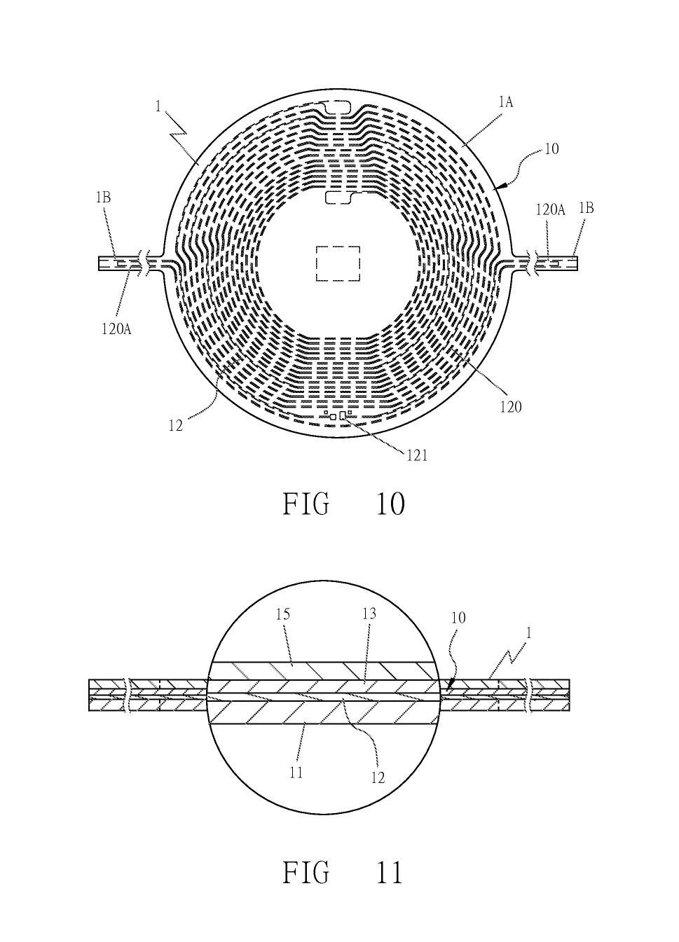

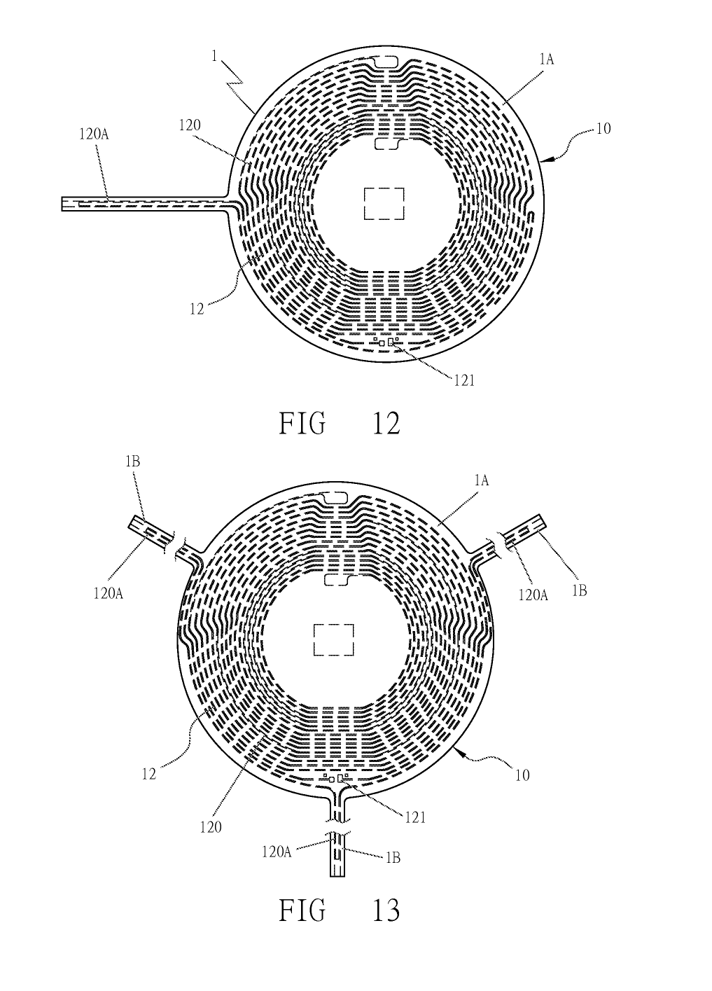

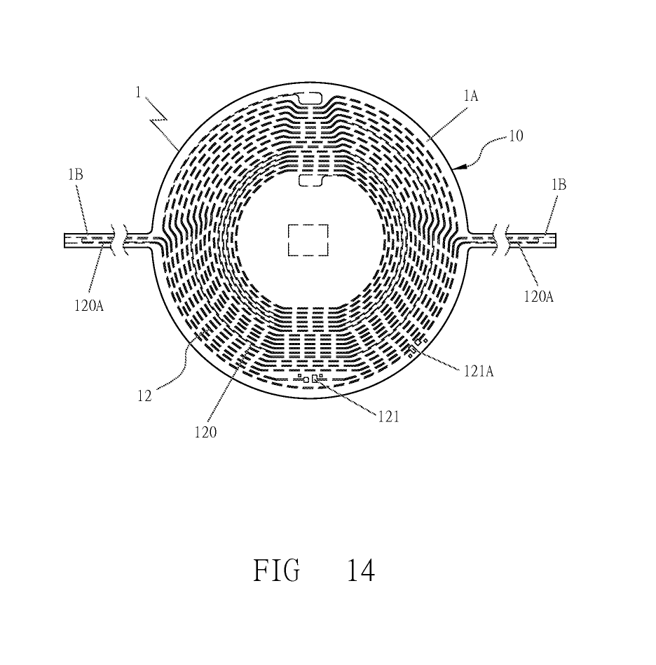

Referring to FIGS. 9-11, the label 1 is provided with a main body 1A for receiving partial substratum plate 11 of the radio frequency identification label 10 and as previously described; the substratum plate 11 is printed thereon with the antennas 120 and the identification chips 121 of the radio frequency identification system 12. The main body 1A is formed with a plurality of extensions 1B for receiving extension antennas 120A of the antennas 120. The extension antennas 120A can be one set, as shown in FIG. 14, or two sets, as shown in FIG. 10 or three sets, as shown in FIG. 13 or more than three sets, depending on practical needs. Referring to FIG. 12, plural identification chips 121, 121A of different purposes of anti-counterfeiting or anti-theft can be provided in this invention for producing different efficacies. For instance, when the extension antennas are broken off, the chips will produce or block off signals to produce different objectives.

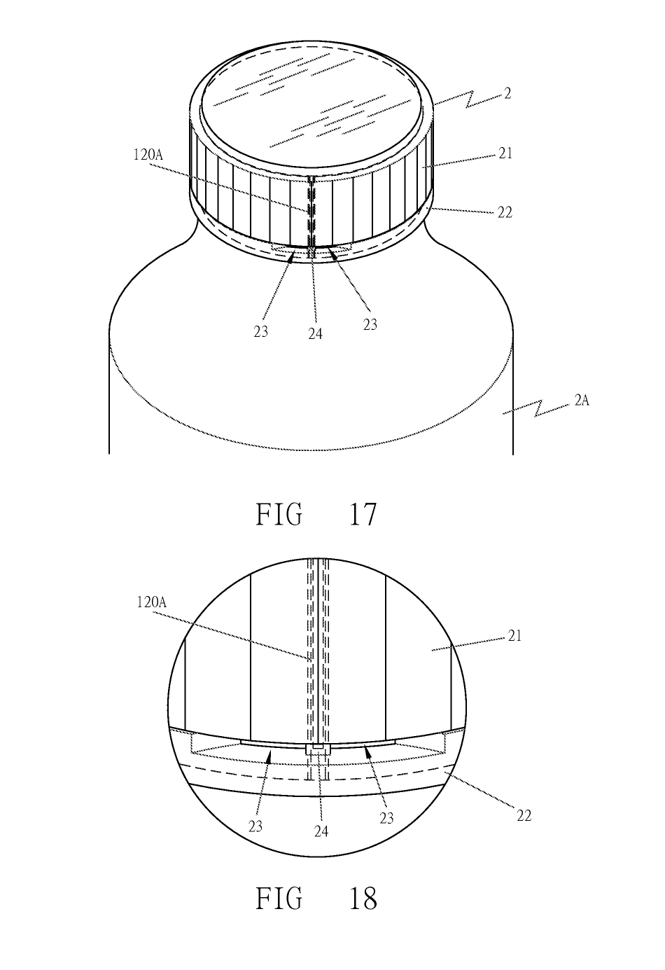

The cap 2, as shown in FIG. 16, is provided with a top wall 20 having its circumferential edge extended downward and formed with a circumferential surface 21 having a positioning circumference 22 disposed at an under side. A plurality of insert holes 23 are bored between the positioning circumference 22 and the circumferential surface 21, as shown in FIGS. 17 and 18, and an abuttal portion 24 is formed between the adjacent insert holes 23.

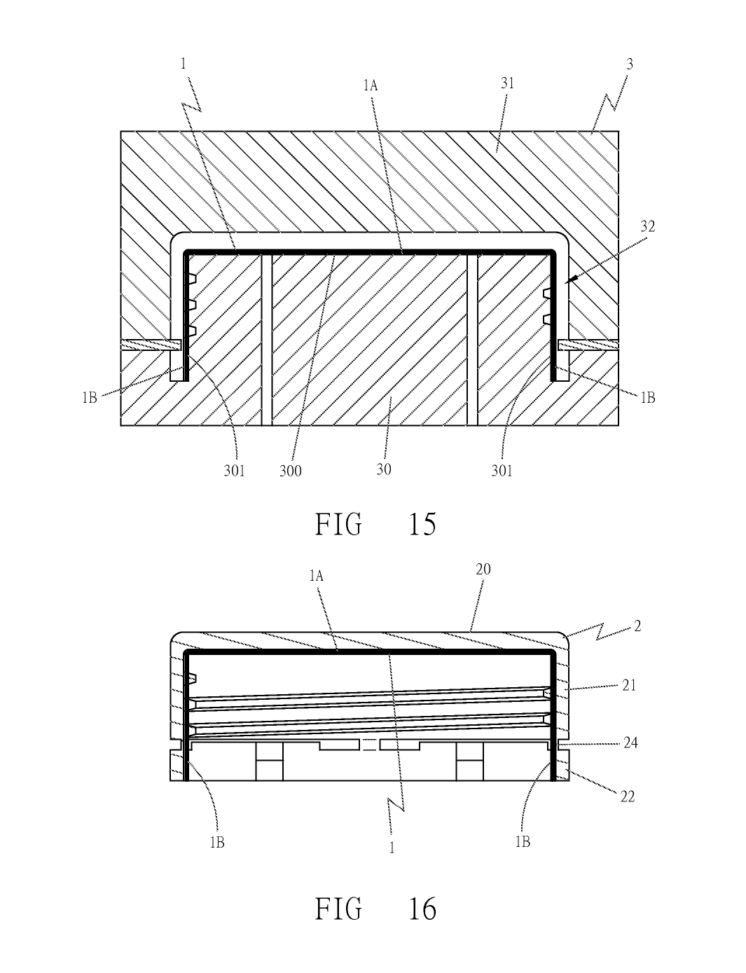

Referring to FIG. 15, through in-mold shaping technique, the label 1 is placed in the male mold 30 of a cap shaping mold 3 beforehand, letting the main body 1A of the label 1 located at a front end 300 of the male mold 30 and the extensions 1B of the label 1 closely touch the inner side 301 of the male mold 30. A shaping slot way 32 for shaping the cap 2 will be formed after the female mold 31 and the male mold 30 of the cap-shaping mold 3 are combined together.

When the cap 2 is shaped in the shaping slot way 32 through plastic injection molding or vacuum forming or blow forming, the main body 1A of the label 1 will be combined with the inner side of the top wall 20 of the cap 2, as shown in FIG. 16, and the extensions 1B of the label 1 will be contacting with the circumferential surface 21 and extended to the positioning circumference 22 of the cap 2.

When the cap 2 of a container 2A is turned open, as shown in FIGS. 17 and 18, the abuttal portion 24 of the circumferential surface 21 and the positioning circumference 22 of the cap 2 will be torn off, letting parts of the extension antennas 120A broken off for blocking or giving out radio frequency identification signals and thus able to produce efficacies of anti-counterfeiting and anti-theft.

While the preferred embodiments of the invention have been described above, it will be recognized and understood that various modifications may be made therein and the appended claims are intended to cover all such modifications that may fall within the spirit and scope of the invention.

What is claimed is:

1. A container cap having identification function comprising:
a label composed of a protective layer and a radio frequency identification label stuck together, said radio frequency identification label made by having a radio frequency identification system provided on a substratum plate and having one side of said radio frequency identification system disposed with a gluey layer to be glued with said protective layer, said label provided with a main body, said main body receiving said radio frequency identification system and antennas, said antennas disposed with extension antennas, said main body provided with a plurality of extensions, said extensions receiving said extension antennas;
a cap formed with a top wall, said top wall provided with a circumferential surface at a lower side, said circumferential surface having an under side disposed with a positioning circumference, a plurality of insert holes bored between said positioning circumference and said circumferential surface, a abuttal portion formed between adjacent insert holes; and
Said label placed in a male mold of a cap shaping mold in advance, said main body of said label contacting with an inner side of said top wall of said cap when said cap is being shaped, said extensions of said label contacting with said circumferential surface and extended to said positioning circumference of said cap, said abuttal portion of said circumferential surface and said positioning circumference of said cap torn off and parts of said extension antennas broken off to block off or send forth radio frequency identification signals when said container cap is turned open, thus producing efficacies of anti-counterfeiting and anti-theft.

2. The container cap having identification function as claimed in claim 1, wherein a first step of manufacturing said label is to have said antennas of said radio frequency identification system of said radio frequency identification label printed or engraved on said substratum plate and have identification chips of said radio frequency identification system fixed on said substratum plate and connected with said antennas through surface mount technique (SMT); a second step is to have one side of said radio frequency identification system on said substratum plate applied with adhesive material to form a gluey layer; a third step is to have said gluey layer of both said basic plate and said radio frequency identification system stuck thereon with a separable layer; a fourth step is to have all said radio frequency identification labels respectively cut into shape by a forming cutter; a fifth step is to remove said radio frequency identification label from said separable layer and have each said radio frequency identification label stuck thereon with a protective layer, which is the same as or partially different from said radio frequency identification label in external appearance, said label thus composed of said radio frequency identification label and said protective layer stuck together.

3. The container cap having identification function as claimed in claim 1, wherein said label is formed with a main body for receiving partial said substratum plate of said radio frequency identification label and said partial substratum plate is provided thereon with said antennas and identification chips of said radio frequency identification system, said main body of said label formed with a plurality of extensions for receiving said extension antennas of said antennas.

4. The container cap having identification function as claimed in claim 1, wherein said extension antennas is one set, or two sets or three sets or more than three sets, depending on practical needs.

5. The container cap having identification function as claimed in claim 1, wherein said radio frequency identification label is installed thereon with a plurality of identification chips, which are differently designed in accordance with the purpose of anti-counterfeiting or anti-theft.

6. A method for manufacturing a container cap having identification function comprising:
(a). Having a label placed in a male mold of a cap-shaping mold in advance through in-mold shaping technique, letting a main body of said label located at a front end of said male mold, extensions of said label closely touching an inner side of said male mold, a cap-shaping slot way formed after a female mold and said male mold are combined together; and
(b). Having said cap shaped in said cap-shaping slot way through plastic injection molding or vacuum forming or blow forming, said main body of said label contacting with an inner side of said top wall of said cap, and said extensions of said label contacting with said circumferential surface and extended to said positioning circumference of said cap.
